(19) United States
(12) Patent Application Publication
(10) Pub. No.: US 2022/0243650 A1
(43) Pub. Date: Aug. 4, 2022

(54) ENGINE WITH SLIDER-CRANK MECHANISM

(71) Applicant: Anatolij Jurevich GALETSKIJ, Dnipro (UA)

(72) Inventors: Taras Jurevich GALETSKIJ, Dnipro (UA); Anton Anatolevich GALETSKIJ, Dnipro (UA)

(21) Appl. No.: 17/617,647

(22) PCT Filed: Jan. 14, 2020
(86) PCT No.: PCT/UA2020/000002

§ 371 Date: Dec. 9, 2021

(30) Foreign Application Priority Data
Jul. 5, 2019 (UA) A 2019 07567

(51) Int. Cl. F02B 75/32; F01B 9/02; F02B 75/24; F01B 1/08; F02B 75/28

(52) U.S. Cl. CPC F02B 75/32; F01B 9/023; F02B 2075/027; F01B 1/08; F02B 75/28; F02B 75/246

(57) ABSTRACT

An engine with a slider-crank mechanism, comprising a housing, containing a shaft with a crank, and at least two cylinders with pistons mounted on rods, the ends of which extend from the pistons through guide bushings of the cylinders and are connected to one another by means of a yoke assembly. A housing of the yoke assembly is configured in the form of a frame having a rectangular cross-section and inner guiding surfaces for a block slider mounted with freedom of movement between said surfaces and with freedom of rotation on the crank of the shaft. The block slider is comprised of two connected halves with grooves for lubricating an outer sliding surface. The housing of the yoke assembly is mounted such that its lateral surfaces are disposed between guiding surfaces inside the engine housing.

### FIELD OF INVENTION

The invention relates to the piston machine, in particular, rodless engines with slider-crank mechanism to convert the reciprocating motion of pistons into rotational motion of the working shaft and can be used both in the engines, for example, internal and external combustion, steam, pneumatic and other engines, and various types of pumps and technological mechanisms.

### BACKGROUND

There is the known engine with slider-crank mechanism comprising a housing, inside which a shaft with a crank is placed, and at least two cylinders with pistons on the rods, the ends of which pass from the pistons through the guide bushings in the housing and are connected to each other by a yoke (clamp) assembly, and the yoke assembly comprise a housing in the form of a frame of rectangular cross-section and internal guide surfaces for the block-slider located between them and installed with freedom of movement between the guide surfaces and rotation on the shaft crank; the block-slider in made of two connected halves with lubrication grooves [U.S. Pat. No. 4,013,048, IPC F01B1/08, F01B9/02, F02B75/24, publ. on 22 Mar. 1977], selected as a prototype.

The known engine has an easy-to-manufacture design for converting the reciprocating motion of pistons on the rods into rotational movement of the shaft.

In the known engine, the piston forces are transmitted by rods to the housing of yoke unit frame and through the block-slider in the frame guides to the shaft crank. In this case, the lateral force perpendicular to the axis of the shaft from the block-slider on the shaft crank in the housing of the yoke frame is taken up by the rod bushings in the engine housing and cylinders from the side surfaces of the pistons in the high-temperature zone with a small amount of lubricant. The consequence is the wear of cylinders from the lateral surfaces of pistons and bushings from the lateral impact of rods, which leads to the loss of compression in the engine, and therefore to failure.

The lubrication grooves on the block-slider extend beyond the sliding plane in the yoke frame housing, which causes a loss of oil pressure in the engine lubrication system.

### SUMMARY

The objective of the invention is to improve the engine with slider-crank mechanism by changing the design parts of the yoke assembly to ensure high-quality wear-free operation of pistons in the cylinders and rods in the bushings of the engine and block-slider of the yoke assembly while increasing the liter capacity and specific output and reducing the internal mechanical losses of the engine.

This task is solved as follows: in the engine with slider-crank mechanism comprising a housing, inside which a shaft with a crank is placed, and at least two cylinders with pistons on the rods, the ends of which pass from the pistons through the guide bushings and are connected to each other by a yoke assembly, and the yoke assembly comprise a housing in the form of a frame of rectangular cross-section and internal sliding guide surfaces for the block-slider located between them and installed with freedom of movement between the sliding guide surfaces and rotation on the shaft crank; the block-slider in made of two connected halves with lubrication grooves; according to the invention, the guide bushings are arranged in the cylinder heads; a yoke assembly housing frame by side surfaces with grooves for lubricant is mounted between the guide surfaces of the engine housing with freedom of movement along the axis of cylinders with double action pistons, and the lubrication grooves on the block-slider do not extend beyond the plane of the internal sliding guide surface in the frame of the yoke assembly.

Wherein the shaft may have one or more than one crank. The engine is made in a two-stroke or four-stroke mode of operation and cylinders with double action pistons are installed at the ends of the housing one after one or in tandem.

In the claimed invention, the forces of the pistons are transmitted by the rods to the frame housing of the yoke assembly, which is moved between the guide surfaces of the engine housing by the side surfaces. The guide surfaces of the engine housing take up the lateral impact on the housing of the yoke frame from the block-slider on the crank. All forces to convert the reciprocating motion of pistons in the cylinders into the rotational motion of the shaft and rotational motion of the shaft into reciprocating motion of pistons on the rods in the slider-crank mechanism from the block-slider block in the internal guides of the frame are transmitted by the side surfaces of yoke frame housing to the guide surfaces of the engine housing. There are no lateral loads on the rod and piston perpendicular to the axis of the shaft from the movement of conversion mechanism. It reduces the wear of the mating surfaces of the rods with guide bushings in the cylinder heads and pistons in the cylinders. Guide bushings of the rods in the cylinder heads are designed to seal gas exchange processes and the unit of rods with pistons in the center of the engine cylinders.

Usage of double action pistons in the engine cylinders instead of single action ones increases the liter capacity at the same dimensions and allows using four-stroke engine operation mode. The absence of lateral loads from the pistons on the surface of cylinders allows increasing the compression ratio due to the boost of the fuel mixture in gasoline engines or air charge in diesel engines, contributing to higher specific output without reducing the resource of the engine.

Lubrication grooves on the block-slider, not extending beyond the plane of the internal sliding guide surface in the frame of the yoke assembly, provide oil pressure stability without any loss in the lubrication system and the engine reliability.

### BRIEF DESCRIPTION OF THE DRAWINGS

The essence of the claimed invention is illustrated by drawings:

FIG. 1 shows a schematic view of the engine with cylinders mounted at the ends of the housing one after one;

FIG. 2 represents a schematic view of the engine with cylinders mounted at the end of the housing in tandem;

FIG. 3 is an isometric schematic view of the yoke assembly frame;

FIG. 4 shows an isometric schematic view of a block-slider.

### DETAILED DESCRIPTION OF THE PREFERRED EMBODIMENT

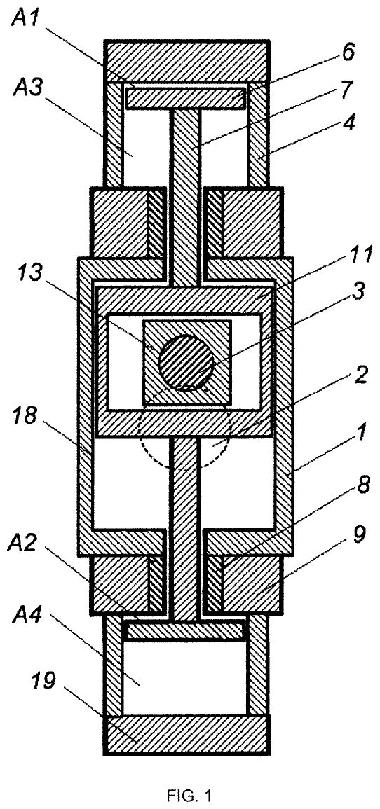

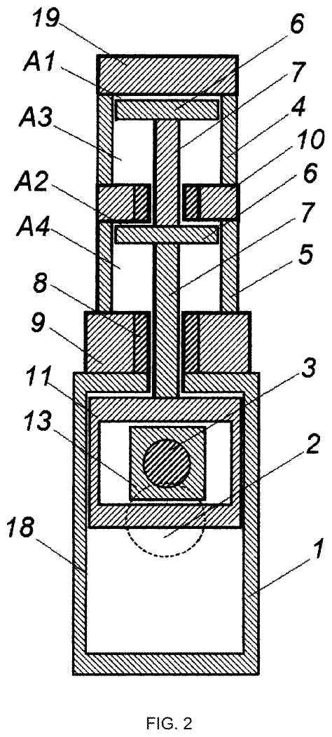

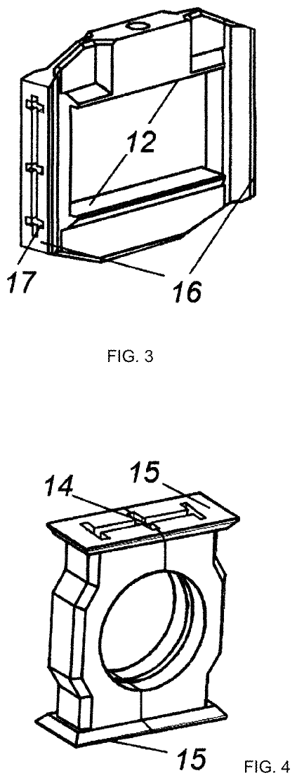

The claimed engine with the slider-crank mechanism comprises a housing 1, inside which a shaft 2 with a crank 3 is placed, and at least two cylinders 4, 5 with the pistons 6 on the rods 7, the ends of which pass from the pistons 6 through the guide bushings 8 in the heads 9 (FIG. 1), 10 (FIG. 2) of cylinders 4, 5 and are connected using a yoke assembly to each other. The yoke assembly comprises a housing 11 in the form of a frame of rectangular cross-section and the internal guide surfaces 12 for the block-slider 13 located between them and installed with freedom of movement between the guide surfaces 12 and rotation on the crank 3 of the shaft 2. The block-slider 13 is made of two connected halves with the grooves 14 for lubrication of the external sliding plane 15. The housing 11 of the yoke assembly frame is mounted by the side surfaces 16 with the grooves for lubricant 17 between the guide surfaces 18 of the housing 1 of the engine with the freedom of movement along the axis of cylinders 4, 5 with the double action pistons 6. The lubrication grooves 14 on the block-slider 13 do not extend beyond the external plane 15 in the frame of the yoke assembly.

It terms of design, it is possible to install the cylinders 4 of double action on the ends of the housing one after one (FIG. 1) or cylinders 4, 5 in tandem (FIG. 2). Owing to this design, in two cylinders of the four-stroke engine between the heads and the double action pistons there are four volumes for simultaneous performance of the four cycles of work. For the design in FIG. 1: A1 and A4 are the volumes between the outer head 19 of cylinder 4 and piston 6; A2, A3 are the volumes between piston 6 and head of cylinder 9. For the design in FIG. 2: A1 is the volume between the outer head 19 of cylinder 4 and piston 6; A2 is the volume between piston 6 and head 10 of the cylinder 5; A3 is the volume between the head 10 of the cylinder 4 and the piston 6; A4 is the volume between the piston 6 and the head 9 of the cylinder 5.

When the fuel mixture is burned in the volume A1, the energy of the gas pressure is used for fresh charge absorption in the volume A2, expulsion of exhaust gases from the volume A3. The compression of the fresh charge in the volume of A4 helps to stop the inertial reciprocating motion of the mass of the pistons 6 and rods 7 with the yoke frame 11, without using the energy of the shaft 2 rotation. The remaining energy of gas pressure from the piston 6 through the rod 7 to yoke frame 11 is used to convert the reciprocating motion of the yoke frame 11 with the use of block-slider 12 on the crank 3 into rotational motion on the shaft 2 of the engine. In this case, the inertia of the shaft 2 rotation experiences minimal alternate loads and does not participate in absorption of the fresh charge, expulsion of exhaust gases, and stopping of the inertial reciprocating motion of the mass of the pistons 6 and the rods 7 with the yoke frame 11. In the prototype, the lateral force perpendicular to the axis of the shaft 2 from the block-slider 13 on the crank 3 of the shaft 2 in the housing 11 of the yoke frame is taken up by the bushings 8 of the rods 7 in the housing 1 of the engine and the cylinders 4 from the side surfaces of pistons 6 in the high temperature zone with a small amount of lubricant. In the claimed engine, the lateral force perpendicular to the axis of the shaft 2 from the block-slider 13 on the crank 3 of the shaft 2 in the housing 11 of the yoke frame is taken up by side surfaces 16 of the housing 11 of the yoke frame in the guide surfaces 18 of the housing 1 of the engine at the low temperature and the necessary amount of lubricant. It leads to a sharp decrease in mechanical losses, and, therefore, to a significant reduction in fuel consumption for obtaining the required engine power, and increasing its resource. With one liter of engine capacity, we get an output of more than 150 horsepower.

What is claimed is:

1. An engine with a slider-crank mechanism, comprising: an engine housing inside which a shaft with a crank is placed, and at least two cylinders with pistons on rods, ends of which extend from the pistons through guide bushings in the housing and are connected to each other by a yoke assembly, and the yoke assembly comprises a housing in a form of a frame of rectangular cross-section and internal guide surfaces for the block-slider located between them and installed with freedom of movement between the guide surfaces and rotation on the shaft crank; the block-slider in made of two connected halves with lubrication grooves, wherein the guide bushings are located in heads of cylinders; the yoke assembly housing frame by side surfaces with grooves for lubricant is mounted between the guide surfaces of the engine housing with freedom of movement along an axis of cylinders with double action pistons, and the lubrication grooves on the block-slider do not extend beyond a plane of an internal sliding guide surface in the frame of the yoke assembly.

2. The engine according to claim 1, wherein the shaft has one or more than one crank.

3. The engine according to claim 1, wherein the engine is made in two-stroke or four-stroke operation mode.

4. The engine according to claim 1, wherein the cylinders with double action pistons are installed at the ends of the housing one after one or in tandem.
